(19) United States
(12) Patent Application Publication
(10) Pub. No.: US 2020/0247941 A1
(43) Pub. Date: Aug. 6, 2020

(54) THERMOSETTING FOAMS HAVING IMPROVED INSULATING VALUE

(71) Applicant: HONEYWELL INTERNATIONAL INC., Morris Plains, NJ (US)

(72) Inventors: Bin Yu, Williamsville, NY (US); Ryan Hulse, Getzville, NY (US)

(21) Appl. No.: 16/777,962

(22) Filed: Jan. 31, 2020

Related U.S. Application Data
(60) Provisional application No. 62/800,022, filed on Feb. 1, 2019.

(51) Int. Cl. C08G 18/42; C08G 18/08; C08G 18/18; C08J 9/00; C08J 9/14; C08G 18/22; C08G 18/16

(52) U.S. Cl. CPC C08G 18/4244; C08G 18/14; C08G 18/1825; C08J 9/0038; C08J 2205/052; C08G 18/1816; C08G 18/225; C08G 18/163; C08J 2203/162; C08J 9/144

(57) ABSTRACT

Disclosed are methods of forming foam comprising: (a) providing a foamable composition comprising an isocyanate, a polyol and a physical blowing agent comprising at least about 50% by weight of hydrohaloolefin, including trans1233zd, and wherein the polyol comprises a polyol or mixture of polyols such that the hydrohaloolefin, including trans1233zd, has a solubility in said polyol of less than about 30%; and (b) forming a foam from said foamable composition.

### CROSS REFERENCE TO RELATED APPLICATIONS

The present application is related to and claims the priority benefit of U.S. Provisional Application 62/800,022.

### FIELD

The present invention relates to thermoset foams, in particular polyurethane foam, a polyisocyanurate foam or a mixture thereof, which achieve improved thermal insulating properties, and to foamable compositions and foaming methods for making same.

### BACKGROUND

The use of foam to provide insulation is well known. For example, insulation boards made from polyisocyanurate (PIR) or polyurethane (PU) foams have been used in commercial, residential and industrial buildings to provide resistance to the flow of heat in and/or out of the buildings. Other forms of PU and PIR foams have also been used at least in part for their thermal insulating value. Such foams may also have low density, excellent fire resistance properties and/or a high strength to weight ratio, depending on the needs of particular applications.

Polyurethane foams are typically produced by reacting a polyisocyanate with one or more polyols in the presence of one or more blowing agents, one or more catalysts, one or more surfactants and optionally other ingredients. In the case of PIR foam, the foam is formed by the reaction of polyisocyanate with itself to form a cyclic trimer structure. In practice, foams commonly described as polyisocyanurate contain both polyurethane and polyisocyanurate structures and foams described as polyurethane often incorporate some polyisocyanurate structures. Thus, the present application relates to polyurethane foams, to polyisocyanurate foams and to mixtures thereof. The blowing agent can be a physical blowing agent or a chemical blowing agent. Physical blowing agents create bubbles in the liquid mixture by volatilizing and expanding due to the heat generated when the polyisocyanate reacts with the polyol, forming bubbles therein. In the case of chemical blowing agents, also known as gas generating materials, gaseous species are generated by thermal decomposition or reaction with one or more of the ingredients used to produce the polyurethane and/or polyisocyanurate foam. As the polymerization reaction proceeds, the liquid mixture becomes a cellular solid, entrapping the blowing agent in the cells of the foam.

It has been common to use certain liquid fluorocarbon blowing agents because of their ease of use, among other factors. Fluorocarbons not only act as physical blowing agents by virtue of their volatility, but also are encapsulated or entrained in the closed cell structure of the foam and are generally the major contributor to the thermal conductivity properties of the foams. After the foam is formed, the k-factor or lambda associated with the foam produced provides a measure of the ability of the foam to resist the transfer of heat through the foam. A foam having a lower k-factor is more resistant to heat transfer and therefore generally a better foam for insulation purposes. Thus, the production of lower k-factor foams is generally desirable and advantageous.

In recent years, concern over climate change has driven the development of a new generation of blowing agents which are able to meet the requirements of both ozone depletion and climate change regulations. Among these are certain hydrohaloolefins including certain hydrofluoroolefins of which 1,3,3,3-tetrafluoropropene (1234ze) and 1,1,1,4,4,4-hexafluorobut-2-ene (1336mzzm) are of particular interest, and hydrochlorofluoroolefins of which 1-chloro-3,3,3-trifluoropropene (1233zd) is of particular interest. Processes for the manufacture of trans-1,3,3,3-tetrafluoropropene are disclosed in U.S. Pat. Nos. 7,230,146 and 7,189,884. Processes for the manufacture of trans-1-chloro-3,3,3-trifluoropropene (trans1233zd) disclosed in U.S. Pat. Nos. 6,844,475 and 6,403,847.

A PIR or PU foam insulation board may be present as part of a building for a long period of time. Estimates of the average thermal conductivity (lambda value or k-factor) over a period of 25 years of use under operational conditions can be made using European standard EN13165 (2010) for factory made rigid polyurethane and polyisocyanurate foam products used as thermal insulation boards for buildings and European Standard EN14315 (2013) for in-situ formed sprayed rigid polyurethane and polyisocyanurate foam products (both of which are incorporated by reference).

The K-factor (or lambda) of a foam has heretofore been generally associated with the thermal insulation properties of the blowing agent which has been used to form the foam. Applicants have found, however, that with certain blowing agents, including particularly trans-1233zd, the interrelationship between the blowing agent and the polyol which is used to make the foam can have a significant impact on not only the initial K-factor of the foam but also the K-factor of the foam after it has been aged. The present invention relies, at least in part, on applicants unexpected discovery of a synergistic relationship between the physical blowing agents, particularly chlorotrifluoropropene blowing agents, including particularly and preferably trans1233zd, and the type of polyol used to form the foam that results in the ability to form foams with enhanced thermal insulating properties, including particularly to foams with enhanced ability to maintain thermal insulating properties after the foam has been aged.

### BRIEF DESCRIPTION OF THE FIGURES

FIG. 1 is a graph showing initial lambda for the PIR foam based different polyols in accordance with the Examples.

FIG. 2 is a graph showing aged lambda for PIR foam based different polyols.

FIG. 3 is a graph showing delta lambda for foam with different polyol in accordance with the Examples.

FIG. 4 is a graph showing initial lambda of each foam with different polyol in accordance with the Examples.

FIG. 5 is a graph showing aged lambda of each foam with different polyol in accordance with the Examples.

FIG. 6 is a graph showing delta lambda of each foam with different polyol in accordance with the Examples.

FIG. 7 is a graph showing impact on lambda of solubility in spray foam in accordance with the Examples.

### SUMMARY

The present invention includes methods of producing thermosetting foams with excellent thermal insulating properties (including preferably low initial, low aged lambda and/or low delta lambda values), said method comprising:

(a) providing a foamable composition comprising an isocyanate, a polyol and a physical blowing agent, wherein said polyol comprises at least about 50% by weight of a low solubility polyol (based on the total of polyol in the foamable composition) relative to said physical blowing agent, and wherein said physical blowing agent comprising at least about 50% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 1.

As used herein, the term “low solubility polyol” means that the hydrofluorolefin physical blowing agent has a solubility in said polyol of not greater than 30%.

As used herein, the term “solubility in polyol” means the solubility as measured in accordance with the procedure identified in the Examples hereof or by a procedure that would provide essentially the same measure +/−2%.

As used herein with respect to percent by weight of a component, “about” means the indicated weight percentage +/−2%.

The present invention also includes methods of producing thermosetting foams with excellent thermal insulating properties (including preferably low initial, low aged lambda and/or low delta lambda values), said method comprising:

(a) providing a foamable composition comprising an isocyanate, a polyol and a physical blowing agent, wherein said polyol comprises at least about 50% by weight of a low solubility polyol (based on the total of polyol in the foamable composition) relative to said physical blowing agent, and wherein said physical blowing agent comprises at least about 50% by weight of trans-1-chloro-3,3,3-trifluoropropene (trans1233zd) (based on the total weight of the physical blowing agent used to form the foam); and

(b) forming a foam from said foamable composition. For the purposes of convenience, methods in accordance with this paragraph are referred to herein as Method 2.

The present invention includes methods of producing thermosetting foams with excellent thermal insulating properties (preferably low initial and low aged lambda values), said method comprising:

(a) providing a foamable composition comprising an isocyanate, a polyol and a physical blowing agent, wherein said polyol comprises at least about 75% by weight of low solubility polyol (based on the total of polyol in the foamable composition), and wherein said physical blowing agent comprises at least about 50% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 3.

The present invention includes methods of producing thermosetting foams with excellent thermal insulating properties (preferably low initial and low aged lambda values), said method comprising:

(a) providing a foamable composition comprising an isocyanate, a polyol and a physical blowing agent, wherein said polyol comprises at least about 75% by weight of low solubility polyol (based on the total of polyol in the foamable composition), and wherein said physical blowing agent comprises at least about 50% by weight of trans1233zd (based on the total weight of the physical blowing agent used to form the foam); and

(b) forming a foam from said foamable composition. For the purposes of convenience, methods in accordance with this paragraph are referred to herein as Method 4.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 90% by weight of low solubility polyol (based on the total of polyol in the foamable composition), and wherein said physical blowing agent comprising at least about 50% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 5.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 90% by weight of low solubility polyol (based on the total of polyol in the foamable composition), and wherein said physical blowing agent comprising at least about 50% by weight of trans1233zd (based on the total weight of the physical blowing agent used to form the foam); and

(b) forming a foam from said foamable composition. For the purposes of convenience, methods in accordance with this paragraph are referred to herein as Method 6.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 50% by weight of low solubility polyol (based on the total of polyol in the foamable composition), and wherein said physical blowing agent comprising at least about 75% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 7.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 50% by weight of polyester polyol (based on the total of polyol in the foamable composition), and wherein said physical blowing agent comprising at least about 75% by weight of trans1233zd (based on the total weight of the physical blowing agent used to form the foam); and

(b) forming a foam from said foamable composition. For the purposes of convenience, methods in accordance with this paragraph are referred to herein as Method 8.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 50% by weight of low solubility polyol (based on the total of polyol in the foamable composition), and wherein said physical blowing agent comprising at least about 95% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 9.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 50% by weight of polyester polyol (based on the total of polyol in the foamable composition), and wherein said physical blowing agent comprising at least about 95% by weight of trans1233zd (based on the total weight of the physical blowing agent used to form the foam); and

(b) forming a foam from said foamable composition. For the purposes of convenience, methods in accordance with this paragraph are referred to herein as Method 10.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 75% by weight of low solubility polyol (based on the total of polyol in the foamable composition), and wherein said physical blowing agent comprises at least about 75% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 11.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 75% by weight of low solubility polyol (based on the total of polyol in the foamable composition), and wherein said physical blowing agent comprises at least about 75% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 12.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 95% by weight of low solubility polyol (based on the total of polyol in the foamable composition), and wherein said physical blowing agent comprising at least about 75% by weight of hydrohaloolefin blowing agent (based on the total weight of the physical blowing agent used to form the foam); and

(b) forming a foam from said foamable composition. For the purposes of convenience, methods in accordance with this paragraph are referred to herein as Method 13.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 95% by weight of low solubility polyol (based on the total of polyol in the foamable composition), and wherein said physical blowing agent comprising at least about 75% by weight of trans1233zd (based on the total weight of the physical blowing agent used to form the foam); and

(b) forming a foam from said foamable composition. For the purposes of convenience, methods in accordance with this paragraph are referred to herein as Method 14.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 95% by weight of low solubility polyol (based on the total of polyol in the foamable composition), and wherein said physical blowing agent comprising at least about 95% by weight of hydrohaloolefin (based on the total weight of the physical blowing agent used to form the foam); and

(b) forming a foam from said foamable composition. For the purposes of convenience, methods in accordance with this paragraph are referred to herein as Method 15.

The present invention includes methods of producing thermosetting foams with excellent thermal insulating properties (preferably low initial, low aged and/or low delta lambda values), said method comprising:

(a) providing a foamable composition comprising an isocyanate, a polyol and a physical blowing agent, wherein said polyol comprises at least about 95% by weight of low solubility polyol (based on the total of polyol in the foamable composition), and wherein said physical blowing agent comprises at least about 95% by weight of trans1233zd (based on the total weight of the physical blowing agent used to form the foam); and

(b) forming a foam from said foamable composition. For the purposes of convenience, methods in accordance with this paragraph are referred to herein as Method 16.

The present invention also includes methods of producing thermosetting foams, including each of Methods 1, 3, 5, 7, 9, 11, 13 and 15, wherein said low solubility polyol comprises a polyol or mixture of polyols in which said hydrohaloolefin blowing agent has a solubility is said polyol of less than about 25%. For the purposes of convenience, methods in accordance with this paragraph are referred to herein as Method 17.

The present invention also includes methods of producing thermosetting foams, including each of Methods 2, 4, 6, 8, 10, 12, 14 and 16, wherein said low solubility polyol comprises a polyol or mixture of polyols in which said trans1233zd has a solubility is said polyol of less than about 25%. For the purposes of convenience, methods in accordance with this paragraph are referred to herein as Method 18.

The present invention also includes methods of producing thermosetting foams, including each of Methods 1, 3, 5, 7, 9, 11, 13 and 15, wherein said low solubility polyol comprises a polyol or mixture of polyols in which said hydrohaloolefin blowing agent has a solubility is said polyol of less than about 20%. For the purposes of convenience, methods in accordance with this paragraph are referred to herein as Method 19.

The present invention also includes methods of producing thermosetting foams, including each of Methods 2, 4, 6, 8, 10, 12, 14 and 16, wherein said low solubility polyol comprises a polyol or mixture of polyols in which said trans1233zd has a solubility is said polyol of less than about 20%. For the purposes of convenience, methods in accordance with this paragraph are referred to herein as Method 20.

The present invention also includes methods of producing thermosetting foams, including each of Methods 1-20, wherein said low solubility polyol comprises polyester polyol. For the purposes of convenience, methods in accordance with this paragraph are referred to herein as Method 21

The present invention also includes methods of producing thermosetting foams, including each of Methods 1-20, wherein said low solubility polyol comprises at least about 50% by weight of polyester polyol. For the purposes of convenience, methods in accordance with this paragraph are referred to herein as Method 22.

The present invention also includes methods of producing thermosetting foams, including each of Methods 1-20, wherein said low solubility polyol comprises at least about 75% by weight of polyester polyol. For the purposes of convenience, methods in accordance with this paragraph are referred to herein as Method 23.

The present invention also includes methods of producing thermosetting foams, including each of Methods 1-20, wherein said low solubility polyol consists essentially of polyester polyol. For the purposes of convenience, methods in accordance with this paragraph are referred to herein as Method 24.

The present invention also includes methods of producing thermosetting foams, including each of Methods 1-20, wherein said low solubility polyol consists of polyester polyol. For the purposes of convenience, methods in accordance with this paragraph are referred to herein as Method 25.

The present invention also provides foams made from any of the methods as described herein, including each of Methods 1-25.

The present invention includes spray foams made in accordance with any of the methods as described herein, including each of Methods 1-25.

The present invention includes sandwich panels foams made in accordance with any of the methods as described herein, including each of Methods 1-25.

The present invention includes sandwich panels foams made in accordance with any of the methods as described herein, including each of Methods 1-25.

The present invention includes appliance foams, including for refrigerators, freezers and water heaters, made in accordance with any of the methods as described herein, including each of Methods 1-25.

The present invention includes boardstock made in accordance with any of the methods as described herein, including each of Methods 1-25.

The present invention includes block foam made in accordance with any of the methods as described herein, including each of Methods 1-25.

The present invention includes pipe foam made in accordance with any of the methods as described herein, including each of Methods 1-25.

The present invention includes pipe foam made in accordance with any of the methods as described herein, including each of Methods 1-25.

The present invention includes vessel insulation foam made in accordance with any of the methods as described herein, including each of Methods 1-25.

The present invention includes pour-in-place foam made in accordance with any of the methods as described herein, including each of Methods 1-25. The present invention includes PIR foam made in accordance with any of the methods as described herein, including each of Methods 1-25.

The present invention includes PIR foam made in accordance with any of the methods as described herein, including each of Methods 1-25.

Each and any of the foams of the present invention as mentioned above can be polyurethane, polyisocyanurate or combinations of the two, including each of Methods 1-25.

### DETAILED DESCRIPTION

### Foams

The present invention provides thermoset foam, preferably polyurethane foam, polyisocyanurate foam or mixture thereof, made by any of the methods hereof, including each of Methods 1-25, having a delta lambda of 7 mW/mK (10° C.) or less. As used herein, the term “delta lambda” refers to delta lambda measured at 10° C. as per the examples hereof.

The present invention provides thermoset foam, preferably polyurethane foam, polyisocyanurate foam or mixture thereof, made by any of the methods hereof, including each of Methods 1-25, having an delta lambda of 7 mW/mK (10° C.) or less. As used herein, the term “delta lambda” refers to delta lambda measured at 10° C. as per the examples hereof.

The present invention provides thermoset foam, preferably polyurethane foam, polyisocyanurate foam or mixture thereof, made by any of the methods hereof, including each of Methods 1-25, having an delta lambda of about 6 mW/mK (10° C.) or less. As used herein, the term “about” as used herein in connection with delta lambda value means the indicated value +/−0.5.

The present invention provides thermoset foam, preferably polyurethane foam, polyisocyanurate foam or mixture thereof, made by any of the methods hereof, including each of Methods 1-25, having a delta lambda of about 5 mW/mK (10° C.) or less. The present invention provides thermoset foam, preferably polyurethane foam, polyisocyanurate foam or mixture thereof, made by any of the methods hereof, including each of Methods 1-25, having an delta lambda of 5.5 mW/mK (10° C.) or less.

The present invention provides thermoset foam, preferably polyurethane foam, polyisocyanurate foam or mixture thereof, made by any of the methods hereof, including each of Methods 1-25, having an initial lambda value of 20 mW/mK (10° C.) or less. As used herein, the term “initial lambda” refers to lambda measured at 10° C. as per the examples hereof.

The present invention provides thermoset foam, preferably polyurethane foam, polyisocyanurate foam or mixture thereof, made by any of the methods hereof, including each of Methods 1-25, having an initial lambda value of about 17 mW/mK (10° C.) or less. The term “about” as used herein in connection with lambda value means the indicated value +/−1.

The present invention provides thermoset foam, preferably polyurethane foam, polyisocyanurate foam or mixture thereof, made by any of the methods hereof, including each of Methods 1-25, having an aged lambda about 27 mW/mK or less. As used herein, the term “aged lambda” refers to lambda measured after the foam has been aged at 70° C. for 21 days in accordance with the procedure as described in the examples hereof.

The present invention provides thermoset foam, preferably polyurethane foam, polyisocyanurate foam or mixture thereof, made by any of the methods hereof, including each of Methods 1-25, having an aged lambda about 26 mW/mK or less.

The present invention provides thermoset foam, preferably polyurethane foam, polyisocyanurate foam or mixture thereof, made by any of the methods hereof, including each of Methods 1-25, having an aged lambda about 25 mW/mK or less.

The present invention provides thermoset foam, preferably polyurethane foam, polyisocyanurate foam or mixture thereof, made by any of the methods hereof, including each of Methods 1-25, having an aged lambda about 24 mW/mK or less.

The present invention provides thermoset foam, preferably polyurethane foam, polyisocyanurate foam or mixture thereof, made by any of the methods hereof, including each of Methods 1-25, having an initial lambda value of 20 mW/mK (10° C.) or less and an aged lambda about 27 mW/mK or less.

The present invention provides thermoset foam, preferably polyurethane foam, polyisocyanurate foam or mixture thereof, made by any of the methods hereof, including each of Methods 1-25, having an initial lambda value of 20 mW/mK (10° C.) or less and an aged lambda about 25 mW/mK or less.

The present invention provides thermoset foam, preferably polyurethane foam, polyisocyanurate foam or mixture thereof, made by any of the methods hereof, including each of Methods 1-25, having an initial lambda value of 20 mW/mK (10° C.) or less and an aged lambda about 24 mW/mK or less.

The present invention provides thermoset foam, preferably polyurethane foam, polyisocyanurate foam or mixture thereof, made by any of the methods hereof, including each of Methods 1-25, having an initial lambda value of 17 mW/mK (10° C.) or less and an aged lambda about 27 mW/mK or less.

The present invention provides thermoset foam, preferably polyurethane foam, polyisocyanurate foam or mixture thereof, made by any of the methods hereof, including each of Methods 1-25, having an initial lambda value of 17 mW/mK (10° C.) or less and an aged lambda about 25 mW/mK or less.

The present invention provides thermoset foam, preferably polyurethane foam, polyisocyanurate foam or mixture thereof, made by any of the methods hereof, including each of Methods 1-25, having an initial lambda value of 17 mW/mK (10° C.) or less and an aged lambda about 24 mW/mK or less.

### Foamable Compositions

As mentioned above, the foamable composition of the present invention includes as essential components thermosetting material (preferably urethanes and/or isocyanurates), polyols and physical blowing agent. Other than as described as being required herein, the specific properties and amounts of these components may be provided over those broad ranges known to those skilled in the art, and additional optional components, including those described below, can also be included with such broad ranges.

### Blowing Agent

For the purposes of this invention, the physical blowing agent preferably comprises at least about 50% by weight of trans-1-chloro-3,3,3-trifluoropropene (1233zd).

Optional co-blowing agents include 1,3,3,3-tetrafluoropropene (1234ze), 1,1,1,4,4,4-hexafluorobut-2-ene (1336mzzm). 1,3,3,3-Tetrafluoropropene (1234ze) can be provided as the cis isomer, the trans isomer or a combination thereof. Preferably, 1,3,3,3-tetrafluoropropene is provided as the trans isomer. 1,1,1,4,4,4-Hexafluorobut-2-ene (1336mzzm) can be provided as the cis isomer, the trans isomer or a combination thereof. Preferably, 1,1,1,4,4,4-hexafluorobut-2-ene is provided as the cis isomer.

The physical blowing agent used in accordance with the methods of the present invention, including each of Methods 1-25, may comprise, consist essentially of, or consist of trans-1-chloro-3,3,3-trifluoropropene (1233zd).

The blowing agent may additionally comprise one or more additional co-blowing agents, such as a hydrocarbon, fluorocarbon, chlorocarbon, fluorochlorocarbon, hydrochlorofluorocarbon, hydrofluorocarbon, halogenated hydrocarbon, ether, fluorinated ether, ester, acetal, alcohol, aldehyde, ketone, organic acid, gas generating material, water, carbon dioxide (CO₂), or combinations thereof. Preferred blowing agents have a Global Warming Potential (GWP) of not greater than 150, more preferably not greater than 100 and even more preferably not greater than 75. As used herein, “GWP” is measured relative to that of carbon dioxide and over a 100-year time horizon, as defined in “The Scientific Assessment of Ozone Depletion, 2002, a report of the World Meteorological Association's Global Ozone Research and Monitoring Project,” which is incorporated herein by reference. Preferred blowing agents have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Preferred optional chemical co-blowing agents include water, organic acids that produce CO₂ and/or CO.

Preferred optional physical co-blowing agents include CO₂, ethers, halogenated ethers; esters, alcohols, aldehydes, ketones; trans-1,2 dichloroethylene; methylal, methyl formate; hydrofluorocarbons, such as 1,1,1,2-tetrafluoroethane (134a); 1,1,2,2-tetrafluoroethane (134); 1,1,1,3,3-pentafluorobutane (365mfc); 1,1,1,2,3,3,3-heptafluoropropane (227ea), 1,1,1,3,3,3-hexafluoropropane (236fa); 1,1,1,2,3,3-hexafluoropropane (236ea); 1,1,1,2,3,3,3-heptafluoropropane (227ea), 1,1-difluoroethane (152a); 1,1,1,3,3-pentafluoropropane (245fa); hydrocarbons such as butane; isobutane; normal pentane; isopentane; cyclopentane, or combinations thereof.

More preferably, the co-blowing agents are one or more selected from water, organic acids that produce CO₂ and/or CO, trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof.

The blowing agent, that is, trans1234zd and any optionally co-blowing agent, is preferably present in foamable composition in an amount of from about 1 wt. % to about 30 wt. %, preferably from about 3 wt. % to about 25 wt. %, and more preferably from about 5 wt. % to about 25 wt. %, by weight of the polyol plus blowing agent in the composition.

### Polyols

As mentioned above, applicants have found that careful selection of the polyols used in the foamable compositions of the present can have an unexpected but highly beneficial effect on the heat transfer resistance of the foam, including the degredation of the heat transfer resistance over time as the foam ages. Accordingly, the polyol according to the present invention should be selected to be in accordance with one of the structural requirements set forth herein (e.g. at least 50% by weight of polyol ester and/or in accordance with one of the solubility requirements set forth herein (e.g., not greater than 25% solubility for trans1233zd). Provided one of the these selections is made as per the teachings hereof, the polyol can be any polyol or polyol mixture which reacts in a known fashion with an isocyanate in preparing a polyurethane foam, a polyisocyanurate foam or a mixture thereof. Useful polyols, in addition to the preferred polyester polyols, optionally can include for example sucrose containing polyol; phenol, a phenol formaldehyde containing polyol; a glucose containing polyol; a sorbitol containing polyol; a methylglucoside containing polyol.

The polyol or mixture of polyols can be present in the foamable composition in an amount, for example of from about 20 wt. % to about 70 wt. %, preferably from about 30 wt. % to about 60 wt. %, and more preferably from about 35 wt. % to about 55 wt. %, based on the total weight of the foamable composition.

Isocyanate

For the purposes of this invention, the isocyanate can be any organic polyisocyanate which can be employed in polyurethane and/or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124.605; and 3,201,372, which are incorporated herein by reference. Preferred as a class are the aromatic polyisocyanates.

Representative organic polyisocyanates correspond to the formula:

R(NCO)_{z}

wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate; arylalkyl polyisocyanates such as xylylene diisocyanate; aliphatic polyisocyanate such as hexamethylene-1,6-diisocyanate, lysine diisocyanate methylester; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, and 4, 4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane. Preferred polyisocyanates are the polymethylene polyphenyl isocyanates, Particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In the present invention, the polyisocyanate and the polyol are preferably employed in amounts which will yield an NCO/OH stoichiometric ratio in a range of from about 0.9 to about 5.0. In the present invention, the NCO/OH equivalent ratio is, preferably, about 1 or more and about 4 or less, with the ideal range being from about 1.1 to about 3. Especially suitable organic polyisocyanate include polymethylene polyphenyl isocyanate, methylenebis(phenyl isocyanate), toluene diisocyanates, or combinations thereof.

### Other Components

Other components that can be included in the foamable composition include silicone surfactant, a non-silicone surfactant, and catalyst (including metal catalyst and an amine catalyst and combinations thereof.

Non-Silicon Surfactants

A non-silicone surfactant, such as a non-silicone, non-ionic surfactant, may include oxyethylated alkylphenols, oxyethylated fatty alcohols, paraffin oils, castor oil esters, ricinoleic acid esters, turkey red oil, groundnut oil, paraffins, and fatty alcohols. A preferred non-silicone non-ionic surfactant is LK-443 which is commercially available from Air Products Corporation or Vorasurf 504 from DOW.

When a non-silicone, non-ionic surfactant used, it is usually present in the composition in an amount of from about 0.25 wt. % to about 3.0 wt. %, preferably from about 0.5 wt. % to about 2.5 wt. %, and more preferably from about 0.75 wt. % to about 2.0 wt. %, by weight based on the weight of polyol, the blowing agent and the silicon in the composition.

Catalysts

Catalysts can include amine catalysts and/or metal catalysts. Amine catalysts may include, but are not limited to, primary amine, secondary amine or tertiary amine. Useful tertiary amine catalysts non-exclusively include N,N-dimethylcyclohexylamine, N,N-dimethylethanolamine, dimethylaminoethoxyethanol, N,N,N′-trimethylaminoethyl-ethanolamine, N,N,N′-trimethyl-N′-hydroxyethylbisaminoethylether, tetramethyliminobispropylamine, 2-[[2-[2-(dimethylamino)ethoxy]ethyl] methylamino] ethanol, pentamethyldiethylene-triamine, pentamethyldipropylenetriamine, N,N,N′,N″,N″-pentamethyl-dipropylenetriamine, 1,1,4,7,10,10-hexamethyltriethylenetetramine, N,N-bis(3-dimethylaminopropyl)-N-isopropanolamine, N′-(3-(dimethylamino) propyl)-N,N-dimethyl-1,3-propanediamine, bis(3-dimethylaminopropyl)-n, n-dimethylpropanediamine, bis-(2-dimethylaminoethyl)ether, N,N′,N″-dimethylaminopropylhexahydrotriazine, tetramethyliminobispropylamine, trimethyl-n′,2-hydroxyethyl-propylenediamine, Bis-(3-aminopropyl)-methylamine, N,N-dimethyl-1,3-propanediamine, 1-(dimethylamino)hexadecane, benzyldimethylamine, 3-dimethylaminopropyl urea, dicyclohexylmethylamine; ethyldiisopropylamine; dimethylisopropylamine; methylisopropylbenzylamine; methylcyclopentylbenzylamine; isopropyl-sec-butyl-trifluoroethylamine; diethyl-(α-phenylethyl)amine, tri-n-propylamine, or combinations thereof. Useful secondary amine catalysts non-exclusively include dicyclohexylamine; t-butylisopropylamine; di-t-butylamine; cyclohexyl-t-butylamine; di-sec-butylamine, dicyclopentylamine; di-(α-trifluoromethylethyl)amine; di-(α-phenylethyl)amine; or combinations thereof.

Other useful amines include morpholines, imidazoles and ether containing compounds. These include:

dimorpholinodiethylether

### N-ethylmorpholine

### N-methylmorpholine

bis(dimethylaminoethyl) ether
imidizole
n-methylimidazole
1,2-dimethylimidazole
dimorpholinodimethylether
N,N,N′,N′,N″,N″-pentamethyldiethylenetriamine
N,N,N′,N′,N″,N″-pentaethyldiethylenetriamine
N,N,N′,N′,N″,N″-pentamethyldipropylenetriamine
bis(diethylaminoethyl) ether
bis(dimethylaminopropyl) ether.

Suitable non-amine catalysts may comprise an organometallic compound containing bismuth, lead, tin, titanium, antimony, uranium, cadmium, cobalt, thorium, aluminium, mercury, zinc, nickel, cerium, molybdenum, vanadium, copper, manganese, zirconium, sodium, potassium, lithium, magnesium, barium, calcium, hafnium, lanthanum, niobium, tantalum, tellunum, tungsten, cesium, or combinations thereof. Preferably, the non amine catalyst comprises an organometallic compound containing bismuth, lead, tin, zinc, sodium, potassium or combinations thereof.

The non-amine catalysts includes, bismuth 2-ethylhexonate, lead 2-ethylhexonate, lead benzoate, stannous salts of carboxylic acids, zinc salts of carboxylic acids, dialkyl tin salts of carboxylic acids (e.g., dibutyltin dilaurate, dimethyltin dineodecanoate, dioctyltin dineodecanoate, dibutyltin dilaurylmercaptide dibutyltin diisooctylmaleate dimethyltin dilaurylmercaptide dioctyltin dilaurylmercaptide, dibutyltin dithioglycolate, dioctyltin dithioglycolate), potassium acetate, potassium octoate, potassium 2-ethylhexoate, glycine salts, quaternary ammonium carboxylates, alkali metal carboxylic acid salts and tin (II) 2-ethylhexanoate or combinations thereof.

Trimerization catalysts can be used for the purpose of converting the blends in conjunction with excess isocyanate to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred trimerization catalysts are potassium acetate, potassium octoate, and N-(2-hydroxy-5-nonylphenol)methyl-N-methylglycinate.

Flame Retardants

Flame retardants are added to foam insulation boards to inhibit or delay the spread of fire by suppressing the chemical reactions in the flame or by forming a protective char layer on the surface of a material. Generally, flame retardants are added to the polyol premix or foamable composition as a liquid or solid. The flame retardants can alternatively be added with the isocyanurate or can be added as a separate stream prior to forming the foam. Generally flame retardants can be mineral based, organohalogen compounds or organophosphorus compounds. Conventional flame retardants used in foam insulation boards include tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(1,3-dichloropropyl)phosphate, and tetra-kis-(2-chloroethyl)ethylene diphosphate, triethylphosphate, ammonium phosphate, various halogenated aromatic compounds, aluminum trihydrate, diethyl-N, N-bis (2-hydroxyethyl) aminomethylphosphonate (Fyrol 6) and melamine.

For the purposes of this invention, the phosphate based flame retardants are preferably selected from the group consisting of tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(1,3-dichloropropyl)phosphate, diethyl-N, N-bis (2-hydroxyethyl) aminomethylphosphonate (Fyrol 6) tetra-kis-(2-chloroethyl)ethylene diphosphate, triethylphosphate and ammonium phosphate, more preferably tris(1-chloro-2-propyl) phosphate (TCPP), triethylphosphate (TEP) and diethyl-N, N-bis (2-hydroxyethyl) aminomethylphosphonate (Fyrol 6).

The amount of the phosphate based flame retardant in the polyol premix composition is preferably 25 phpp or less, preferably 20 phpp or less, preferably 15 phpp or less, preferably 10 phpp or less, preferably 5 phpp or less. Preferably, the foamable composition does not contain a phosphate based flame retardant.

The flame retardants can be blended with the polyols and therefore provided in the polyol premix composition with the polyol or mixture of polyols, prior to the production of the foamable composition. Alternatively, the flame retardants can be added as a separate stream during the formation of the foamable composition. For the purposes of this invention, the amount of phosphate based flame retardant includes all phosphate-based flame retardant, i.e. the amount of phosphate based flame retardant present in the polyol premix composition or added as a separate stream during the formation of the foamable composition.

The inventors have unexpectedly found that by limiting the amount of the phosphate based flame retardant in the polyol premix composition to 25 phpp or less, it is possible to reduce the lambda aging of a polyurethane foam, a polyisocyanurate foam or a mixture thereof produced from the polyol premix composition after 21 days aging at 70° C.

Others

In addition, other ingredients such as, dyes, fillers, pigments and the like can be included in the polyol premix composition. Dispersing agents and cell stabilizers can used. Conventional fillers for use herein include, for example, aluminum silicate, calcium silicate, magnesium silicate, calcium carbonate, barium sulfate, calcium sulfate, glass fibers, carbon black and silica. The filler, if used, is normally present in an amount by weight ranging from about 5 parts to 100 parts per 100 parts of polyol. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

### Foaming Methods

The preparation of polyurethane and/or polyisocyanurate foams using the blowing agent, polyol, optional other components and an isocyanate may follow any of the methods well known in the art for forming foams, see Saunders and Frisch, Volumes I and II Polyurethanes Chemistry and Technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, Ohio, all of which are incorporated herein by reference. In general, polyurethane and/or polyisocyanurate foams are prepared by combining inter alia an isocyanate and a polyol premix composition. The produced foams are preferably closed cell foams which can be rigid or semi-rigid. Preferably the produced foams are rigid foams.

For the purposes of this invention, the isocyanate can be provided in combination with other components, such as certain silicone surfactants. The isocyanate can be combined with the blowing agent, but it is envisaged in this application, that the blowing agent will at least primarily comprise the polyol premix composition of the first aspect. The invention does however encompass the option wherein at least a portion of the blowing agent is combined with the isocyanate.

The polyurethane foam, polyisocyanurate foam or mixtures thereof are prepared by bringing together the isocyanate and polyol premix composition either by hand mix for small preparations and, preferably, machine mix continuous or discontinuous production techniques to form boards, blocks, slabs, laminates, pour-in-place panels and other items, spray applied foams, froths, and the like. Optionally, other ingredients such as colorants, auxiliary blowing agents, water, catalysts, and even other polyols can be added as a stream to the mix head or reaction site. Most conveniently, however, they are all, incorporated into the polyol premix composition as described above.

For the purposes of this invention, the polyurethane foam, polyisocyanurate foam or mixtures thereof are produced as continuous or discontinuous pour in place panels, boards or spray applied foams.

In particular, when the foam is provided as a board or a panel, the foam can be produced by pouring the foamable mixture between two facings of a panel, allowing the foam to rise to produce a “foam sandwich” which is cut to the desired length. The facings of the panel can be aluminium foil, roofing paper, metal, wood, etc. The resulting boards or panels can then be applied to an existing building envelope or used to form a building envelope. These panels can be produced by both a continuous or by a discontinuous process.

The polyurethane foam, polyisocyanurate foam or mixtures thereof produced can vary in density from about 0.5 pounds per cubic foot to about 60 pounds per cubic foot, preferably from about 1.0 to 20.0 pounds per cubic foot, and most preferably from about 1.5 to 6.0 pounds per cubic foot. The density obtained is a function of how much of the blowing agent or blowing agent mixture plus the amount of auxiliary blowing agent, such as water or other co-blowing agents is used to prepare the foam.

### Uses

Among many uses, the foams of the present invention may be used to insulate buildings (e.g. building envelope) or any construction where energy management and/or insulation from temperature fluctuations on its exterior side are desirable. Such structures include any standard structure known in the art including, but not limited to those, manufactured from clay, wood, stone, metals, plastics, concrete, or the like, including, but not limited to homes, office buildings, or other structures residential, commercial, industrial, agricultural, or otherwise where energy efficiency and insulation may be desirable.

Thus, an aspect of the invention relates to a board foam, a foam core panel or a spray foam produced by the method of the first aspect of the invention.

### Experimental Procedure

### Polyol Blend:

Blends were prepared by mixing the materials based on formulations below.

### Foaming:

The foam was made by hand mixing based on the formulations listed below. A mold (30 cm*30 cm*10 cm) was used.

### Lambda Value:

The lambda value was recorded using the LaserComp FOX50 with a sample size of 20 cm×20 cm×2 cm.

1233zd(E) Gas Solubility:

the solubility of 1233zd(E) in polyol/flame retardants are measured using gravimetric methods which utilize a microbalance. The microbalance is made by VTI model GHP (High Pressure Gravimetric Analyzer). The sample is in an environment filled with the pure gas and the weight gain of sample is measured vs. time in constant temperature and pressure. From the time-dependent data, solubility can be determined from the initial and equilibrium weight.

### Example #1-1233zd(E) Gas Solubility in Different Polyols

Various polyols, including polyester polyols with different functionality, polyether polyols with different functionality/different initiators were selected for the study of 1233zd(E) gas solubility at 30° C. by measuring the weight gain in a microbalance. Table 1 Summarized the 1233zd(E) gas solubility in various polyols.

| Polyol | 1233zd(E) gas solubility (30° C.) |
|---|---|
| Terate HT 5510 | 17.4% |
| Isoexter 4404-US | 13.4% |
| Stepanpol PS 2352 | 23% |
| Terate HT 2000 | 21.4% |
| Terate 5350 | 16.9% |
| Terol 649 | 16.5% |
| Voranol 391 | 41.5% |
| Voranol 350X | 30.4% |
| Voranol 470X | 47.2% |
| Voranol 360 | 48.3% |
| Voranol 270 | 70.8% |

Among the polyol studied, Isoexter 4404-US showed the lowest solubility for 1233zd (E) gas, while Voranol 270 displayed highest solubility. Applicants have found that, generally, polyester polyol tend to have lower solubility for 1233zd(E) than polyether polyol.

### Example 2 Initial Lambda of PIR Foam Based on Different Polyols

Table 2 shows the composition of the polyol preblend. These preblends were used in the preparation of the PIR foams by reacting with isocyanate M20 with the same index of 250.

TABLE 2

| Component | Phpp |
|---|---|
| Polyol | 100 |
| Niax L6900 | 2 |
| Dabco K15 | 1.6 |
| Polycat 8 | 0.5 |
| Polycat 5 | 0.3 |
| TCPP | 15 |
| Water | 0.8 |
| 1233zd(E) | 33 |

After the fresh made foam was cured for 24 hours, a core foam with a dimension of 20 cm×20 cm×2 cm was cut for the initial lambda measurement.

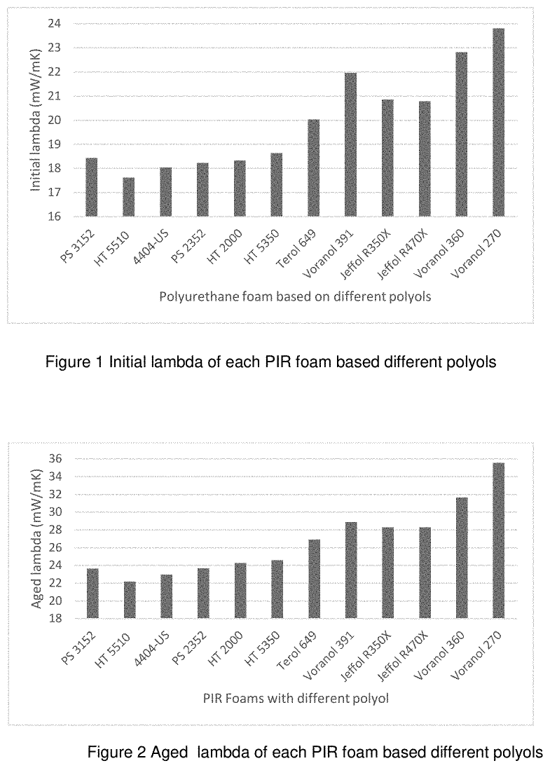

The initial lambda of the each PIR foam varied significantly, as shown in FIG. 1. The foam which had used polyester polyol of Terate HT 5510 has the best initial lambda of 17.62 mW/mK (10° C.), while the foam which had used the polyether polyol Voranol 270 had the worst initial lambda of 23.8 mW/mK.

### Example 3 Aged Lambda of PIR Foam Based on Different Polyols

After the initial lambda was recorded, the same exact foam was put into an oven to age for 21 days at 70° C. based on the requirement of the Normality test of EN 13165. The lambda value (aged lambda) was measured again from such aged foam samples. The aged lambda of the PIR foams varied significantly depending on which polyol had been used for the preparing of the foam, as shown in FIG. 2. The foam with the best aged lambda was the one which used Terate HT 5510, while the foam prepared from Voranol 270 had the worst aged lambda

### Example 4 Aging Performance of PIR Foam Based on Different Polyols

The aging performance of the foam can be judged with the delta lambda value which was obtained based on the difference between the aged lambda and initial lambda:

Delta lambda=Aged lambda−Initial lambda

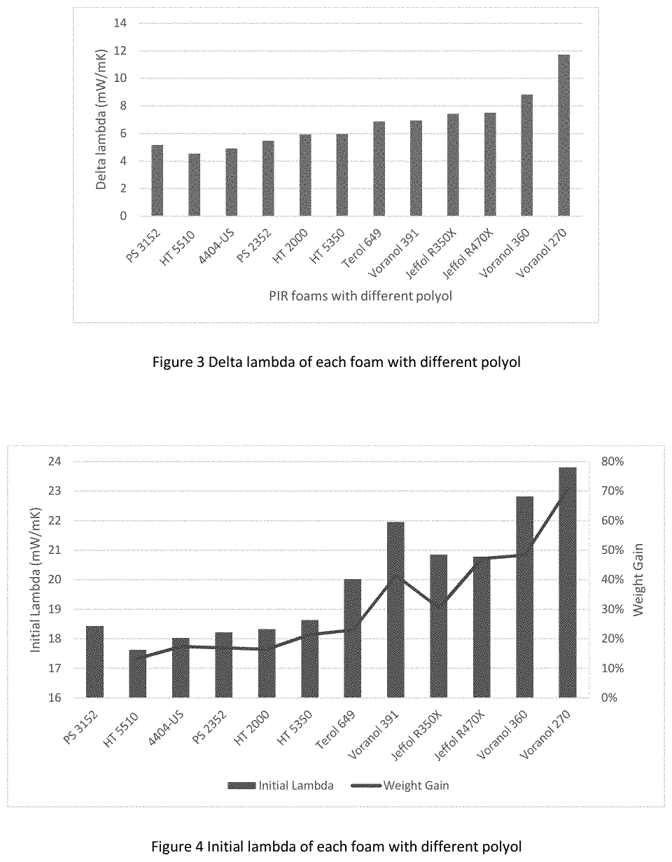

FIG. 3 demonstrated that the aging performance (delta lambda) of each foam depended on the polyol used in the foam. The foam which used Terate HT 5510 had the best aging performance with the lowest delta lambda of 4.53 mW/mK, while the foam which used Voranol 270 has the worst aging performance with a delta lambda of 11.72 mW/mK. Such a trend matches the observation for the impact of polyol on initial lambda of each foam.

### Example 5 Correlation Between Gas Solubility and Initial Lambda, Aged Lambda and the Delta Lambda of Each Foam

As illustrated in FIG. 4, the results of Example 4 indicate that there was a correlation between the 1233zd(E) solubility in each polyol (shown in the Figure by the line and the value on the right y-axis) and the initial lambda of the PIR foams (shown in the Figure by the bars and the value on the left y-axis). The foam with best initial lambda contained the polyol with lowest solubility for 1233zd(E) gas.

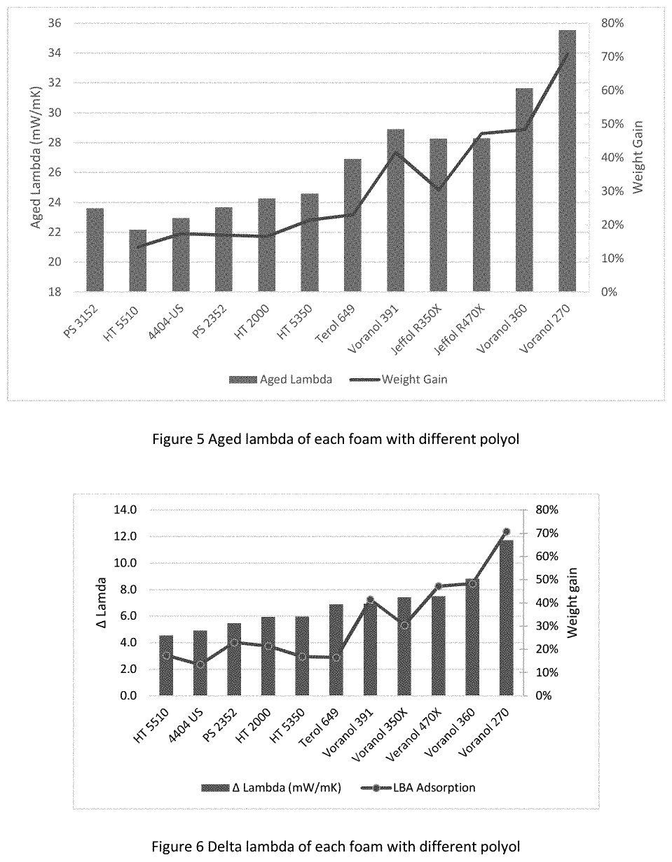

There was a similar correlation between the aged lambda of the foam and the gas solubility of 1233zd(E) which was used for the preparation of the foam (see FIG. 5, in which solubility in each polyol is shown in the Figure by the line and the value on the right y-axis and the aged lambda of the PIR foams is shown in the Figure by the bars and the value on the left y-axis).

Similar conclusion can be drawn between the gas solubility of 1233zd(E) in each polyol and the aging performance of the foam which had used the polyol (FIG. 6).

### Example 6 Impact of Gas Solubility of 1233zd(E) on Lambdas of Spray Foams

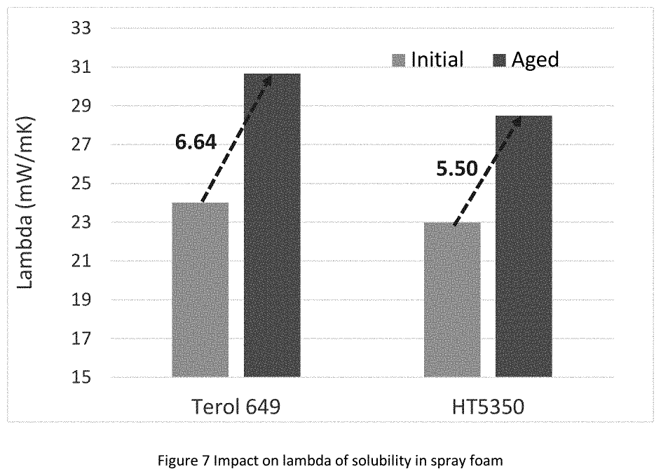

The impact of gas solubility of 1233zd(E) in polyols on lambda values was observed in a spray foam and is illustrated in FIG. 7. The spray foam formulation tested is described in Table 3.

TABLE 3

| Component | Phpp | Phpp |
|---|---|---|
| Terol 649 | 60 | |
| HT5350 | | 60 |
| Voranol 470X | 30 | 30 |
| Voranol 360 | 10 | 10 |
| PHT-4-Diol | 3 | 3 |
| TCPP | 10 | 10 |
| DC 193 | 1.5 | 1.5 |
| K-15 | 1 | 1 |
| Dabco 2040 | 5 | 5 |
| Water | 2.5 | 2.5 |
| LBA | 12 | 12 |

The polyol Terol 649 has a higher gas solubility of 1233zd(E) than polyol Terate HT5350. When Terol 649 was replaced by Terate HT 5350 in the spray foam, all lambda values were improved.

1. A method of producing thermosetting, thermal insulating foam comprising:
(a) providing a foamable composition comprising an isocyanate, a polyol and a physical blowing agent, wherein said polyol comprises at least about 50% by weight of low solubility polyol relative to said physical blowing agent, and wherein said physical blowing agent comprising at least about 50% by weight of trans-1-chloro-3,3,3-trifluoropropene (trans1233zd); and
(b) forming a foam from said foamable composition.

2. The method of claim 1 wherein the foam has an initial lambda less than or equal to 20 mW/mK.

3. The method of claim 1 wherein the foam has an aged lambda less than or equal to 27 mW/mK.

4. The method of claim 1 wherein the foam has a delta lambda less than about 7 mW/mK.

5. The method of claim 4 wherein said polyol comprises at least about 75% by weight of low solubility polyol.

6. The method of claim 4 wherein said polyol comprises at least about 75% by weight of polyester polyol.

7. The method of claim 6 wherein said physical blowing agent comprising at least about 75% by weight of said trans1233zd.

8. The method of claim 4 wherein said polyol comprises at least about 90% by weight of low solubility polyol.

9. The method of claim 8 wherein said physical blowing agent comprising at least about 75% by weight of said trans1233zd.

10. The method of claim 1 wherein said low solubility polyol comprises a polyol or mixture of polyols in which said trans1233zd has a solubility is said polyol of less than about 25% and wherein said foam has a delta lambda less than about 6 mW/mK.

11. A methods of producing thermoset thermal insulating foam comprising:
(a) providing a foamable composition comprising an isocyanate, a polyol and a physical blowing agent, wherein said physical blowing agent comprises at least about 50% by weight of trans-1-chloro-3,3,3-trifluoropropene (trans1233zd), and wherein said polyol comprises a polyol or mixture of polyols such that said trans1233zd has a solubility is said polyol of less than about 25%; and
(b) forming a foam from said foamable composition.

12. The method of claim 11 wherein said polyol comprises a polyol or mixture of polyols such that said trans1233zd has a solubility is said polyol of about 20% or less.

13. The method of claim 12 wherein said polyol comprises a polyol or mixture of polyols such that said trans1233zd has a solubility is said polyol of about 17% or less.

14. The method of any of claim 13 wherein the foam has an initial lambda less than or equal to 20 mW/mK.

15. The method of claim 13 wherein the foam has an aged lambda less than or equal to 27 mW/mK.

16. The method of claim 13 wherein the foam has a delta lambda less than about 7 mW/mK.

17. The method of claim 14 wherein the foam has a delta lambda less than about 7 mW/mK.

18. The method of claim 13 wherein the foam has a delta lambda less than about 6 mW/mK.

19. The method of claim 14 wherein the foam has a delta lambda less than about 6 mW/mK.

20. The method of claim 19 wherein said physical blowing agent comprises at least about 75% by weight of trans1233zd.
